(19) United States
(12) Patent Application Publication
(10) Pub. No.: US 2006/0234637 A1
(43) Pub. Date: Oct. 19, 2006

(54) Method and apparatus for measuring highly reflective channel performance

(75) Inventor: Richard Mellitz, Irmo, SC (US)

Correspondence Address: FLESHNER-KIM, LLP;INTEL CORPORATION, P.O. BOX 221200, CHANTILLY, VA, 20153-1200, US

(73) Assignee: Intel Corporation

(21) Appl. No.: 11/108,773

(22) Filed: Apr. 19, 2005

(51) Int. Cl. H04B 17/00

(52) U.S. Cl. 455/67.11

(57) ABSTRACT

A serial communications link includes a plurality of projections disposed on a reference channel. The projections may be disposed at predetermined angles relative to a signal propagation axis of the reference channel, and may be spaced to tune the reference channel to a predetermined jitter profile based on a data rate through the channel.

### FIELD

The present invention relates in at least some of its embodiments to improving signal propagation efficiency in a serial communications link.

### BACKGROUND OF THE INVENTION

A serial communications link is formed from at least one channel 1 connected between a transmitter 2 and receiver 3, as shown in FIG. 1. The transmitter and receiver are typically housed within integrated-circuit packages, and a conductive trace on a printed circuit board usually serves as the channel, however other physical interfaces are also possible. Because the components of the link are often supplied by different manufacturers, inconsistencies may arise in terms of their electrical characteristics which degrade signal propagation efficiency, and in a worst case render them inoperable with one another.

In order to achieve interoperability, a plurality of AC parameters (including voltage and timing margins) must be defined. These parameters are not only set to match the electrical characteristics of the transmitter and receiver with the channel, but also to reduce insertion loss and jitter effects generated at the boundaries between the channel and IC packages.

Conventional techniques for achieving interoperability within the link require adjustment a priori of a large number (e.g., 15) of parameters. These parameters include equalization tap coefficients, transmitter pre-emphasis, Max Tax, voltage, receiver and transmitter eye parameters, eye width and height, transmitter jitter, transmitter and receiver AC common mode and equalization parameters. Adjusting a large number of parameters increases the complexity of implementing the link as well as processing overhead.

### BRIEF DESCRIPTION OF THE DRAWINGS

FIG. 1 is a diagram showing the components of a serial communications link.

FIG. 2 is a graph showing a pass/fail curve used to determine whether a reference channel in a serial communication link is operating at acceptable performance levels.

FIG. 3 is a flow diagram with functional blocks included in a method for adjusting parameters of a serial communications link in accordance with one embodiment of the present invention.

FIG. 4 is a diagram showing an example of a stub resonator that may be used as a reference channel in accordance with the functional blocks shown in FIG. 3.

FIG. 5 is a graph showing a frequency response for the reference channel of FIG. 4 having 150 μm stubs with equal λ/8 spacing.

FIG. 6 is a graph showing a frequency response for a reference channel used in connection with the stub resonantor.

FIG. 7 is a graph showing a voltage-time eye diagram for the stub-resonant reference channel based on the frequency response shown in FIG. 5.

FIG. 8 is a graph showing a voltage-time eye diagram for a loss-based channel.

FIG. 9 is a diagram showing a processing system having serial links with performance parameters adjusted in accordance with one or more of the embodiments of the method of the present invention.

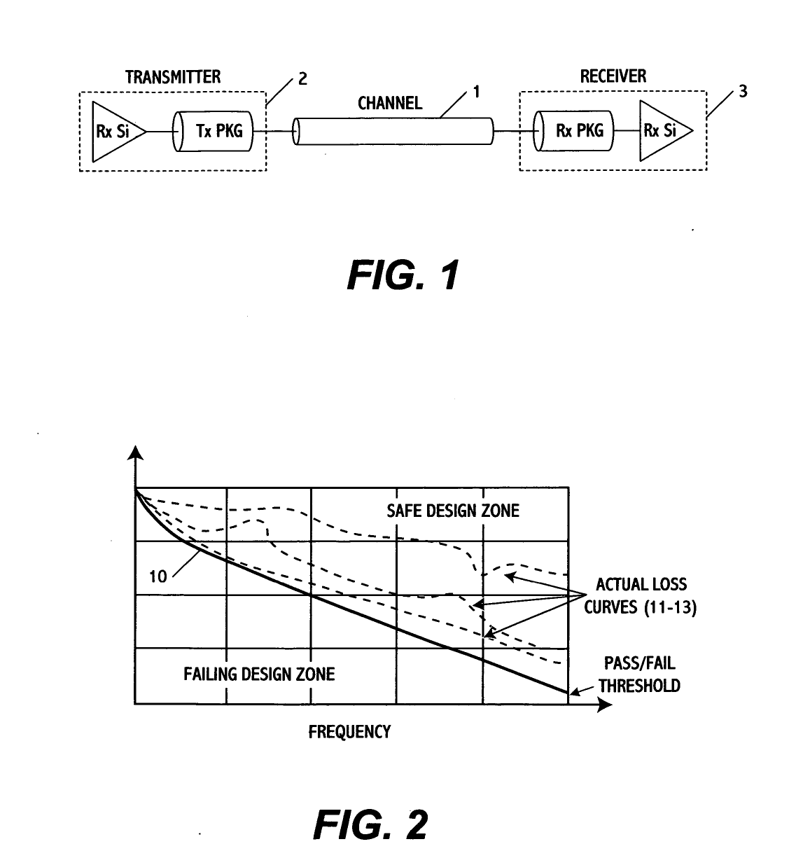

### DETAILED DESCRIPTION

The interoperability among the components of a serial communications link is determined based on the individual performance characteristics of the components. In accordance with the embodiments described herein, this performance is characterized in conjunction with or comparison to a loss-based reference channel, which provides a basis for determining whether the link exhibits an acceptable level of performance under various operating conditions.

FIG. 2 is a graph showing an example of this performance, where reference-channel loss is plotted against frequency characteristics of the link. In this graph (corresponding to the AC sine wave frequency response), reference curve 10 is included to define minimum performance characteristics of the link for a given application. The link is then tested under various operating conditions and/or sets of AC parameters to determine whether performance is acceptable. Actual loss curves 11, 12, and 13 which reside above pass/fail curve 10 are in a channel-pass region (safe design zone) and demonstrate an acceptable level of performance. Curves that fall blow curve 10 are in a fail performance region (failing design zone) and demonstrate an unacceptable level of performance.

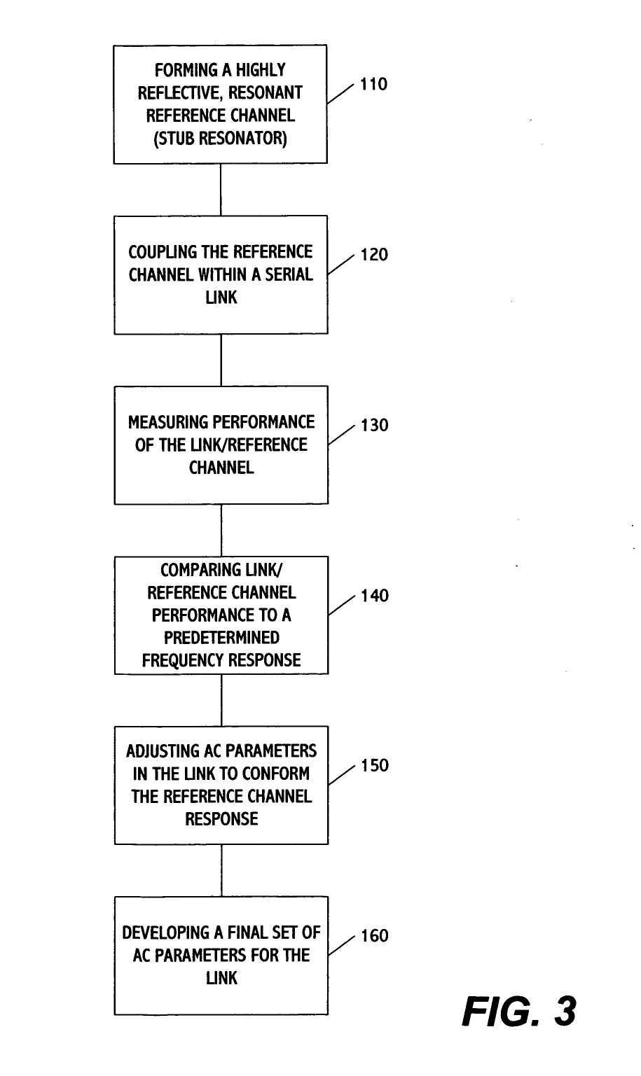

FIG. 3 shows functional blocks included in a method for adjusting the parameters of a serial communications link in accordance with one embodiment of the present invention. The method includes forming a reference channel which, for example, may correspond to a physical interface such as but not including a conductive trace on a printed wiring board. (Block 110).

The reference channel is made so that it demonstrates highly resonant, reflective behavior (e.g., demonstrates reflection-dominated characteristics as opposed to loss-dominated characteristics) for a predetermined timing margin. To ensure optimal transmission efficiency through the link, a worst-allowable (e.g., minimum possible) timing margin for a given application may be used. However, the channel may be adjusted for timing margins that correspond to other levels of performance or the requirements of other applications. Also, while timing margin is one parameter upon which the reflective behavior of the reference channel may be based, other parameters may be used as the basis for generating the highly resonant reflective behavior of the channel.

When practically applied, the vias on a printed wiring board produce electrical effects similar to stubs and will cause otherwise properly calibrated channels to demonstrate highly reflective, resonant behavior. In some cases, the reflections on a short-channel may be tolerable, but for longer channels the effects (including attendant insertion loss) become more pronounced and may cause performance of the link to drop below a pass/fail curve as exemplified in FIG. 2. This is especially true when the transmitter and receiver are incorporated within IC packages, where substantial reflections occur at the transmitter-channel boundary and the channel-receiver boundary. These reflections can resonate with other channel features (such as vias, line segments, and connectors) and subsequently produce data reception failures.

To compensate for these effects, operating parameters of the link may be adjusted to ensure that the link demonstrates acceptable performance levels (e.g., losses are above a pass-fail curve) even in the presence of vias on a printed wiring board. This is accomplished by connecting a stub resonator which simulates the reflectivity and resonance that vias induce on a link channel, measuring the channel (or link) performance against a predetermined criteria, and then adjusting a set of AC parameters of the link to achieve a level of performance that satisfies that criteria. To ensure optimal performance, the criteria selected may correspond to worst-allowable conditions that may be expected to occur for a given application.

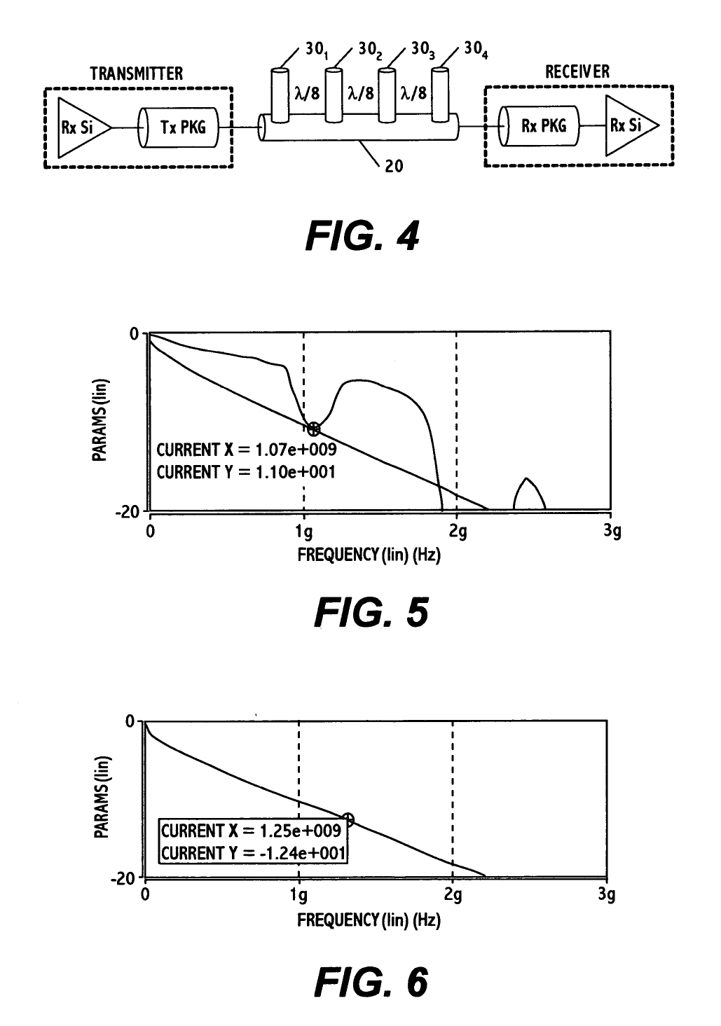

FIG. 4 shows one type of reference channel 20 that can be used as the stub resonator in the present embodiment. The reference channel includes a plurality of projections 30₁, 30₂, 30₃, . . . 30_{N} formed, for example, using the same deposition and etching techniques relied on to form internal or inter-layer structures (e.g., studs) during integrated circuit fabrication. From a functional standpoint, the projections (which, for example, may be stubs) create reflections which alter the propagation velocity of the signals in the channel at certain frequencies determined, for example, by the spacing. The stubs also operate as a filter with respect to these frequencies.

The stubs are spaced to tune the reference channel so that the channel exhibits an intended level of performance. The stubs may be spaced to achieve a predetermined jitter profile, which, for example, may correspond to a worst-case jitter (caused, for example, by reflections and resonance from PWB vias) at a predetermined (e.g., maximum) data rate the channel is capable of handling, or which is within allowable limits given an intended application. Worst-case jitter may, for example, be the maximum-allowable jitter determined by prior measurements or known frequency response curves.

To enhance communication efficiency, the stub spacing may be chosen to tune the reference channel so that a minimum performance level corresponds to the worst-case jitter profile, e.g., determinable where resonance repeats at regular frequency multiples. Tuning the channel in this manner will minimize insertion losses at the channel boundaries and will therefore reduce or eliminate data reception failures, especially when the transmitter and receiver IC packages are highly reflective so as to resonate with other features of the channel.

While worst-case jitter may be used as the criteria for determining the stub spacing, other criteria may be used including but not limited to other jitter profiles or insertion loss requirements. For example, stub-length interaction may be taken into consideration for purposes of determining stub spacing as well as non-TEM anomalies including trace bend, connectors, and dielectric anomalies. The stub spacing may also be chosen to tune the channel based on other data rates or performance requirements depending, for example, on the application.

In accordance with one embodiment, the spacing between the stubs is proportional to a predetermined fraction of a signal wavelength passing through the channel. The signal wavelength may be a maximum signaling rate frequency wavelength (λ) given by the following formula:
λ=(εᵣ·c)^{1/2}/Freq
where c is the speed of light, εᵣ is a dielectric constant of the channel, and Freq is the signal frequency. In one exemplary application shown in FIG. 4, the stub spacing at least substantially equals one-eighth of the signal wavelength (λ/8) through the channel. In other applications, the spacing between the stubs may be unequal, for example, to tune different forms of pass-band ripple.

The stubs may also be formed at predetermined angles relative to the signal propagation axis of the channel. The stubs may be at least substantially perpendicular to the propagation axis as this produces better predictability of performance in the channel, however other angles are possible. For example, at least two of the stubs may be disposed at different angles relative to the signal propagation axis of the channel.

The size of the stubs may also affect the performance of the reference channel. In FIG. 4 the stubs are all the same length (e.g., 150 μm), however other lengths may be used. For example, the lengths of the stubs may be equal to the spacing between the stubs, e.g., stub spacing and length may both be equal to λ/8. In other cases, the stub length may be varied along the length of the channel, in combination with either an equal or unequal spacing. Using unequal stub lengths (e.g., a mixture of 150 μm and 60 μm lengths in either a regular or irregular pattern) rather than unequal stub spacing may be used as a way of bounding performance of the channel.

FIG. 5 shows the resulting frequency response obtained for the reference channel of FIG. 4, having 150 μm stubs with equal λ/8 spacing. In FIG. 5, lower line 60 shows the frequency response of an insertion loss-dominated channel and upper curve 5 shows the frequency response of the reflection-loss stub resonant reference channel produced by FIG. 4.

A loss-dominated channel has a smooth sdd21 curve and relatively constant group delay curve in the frequency range of interest, e.g., approximately 1.2*Nyquist rate for at least one application. This channel is equal to the channel of FIG. 4 without the stubs and serves as a pass-fail reference line (like curve 10 in FIG. 2) for the stub-resonant reference channel. The curve for the stub-resonant reference channel is shows as being above the pass-fail curve for worst-case jitter for a maximum data rate through the channel. The stub resonator of the present embodiment, thus, operates to bound the wiggle on the sdd21 curve.

FIG. 6 shows a frequency response for the reference channel. As shown, the rippled s21 (FIG. 5) produces a more closed eye than the reference channel in the stub resonator of FIG. 4, even though it is considerably shorter and has less loss.

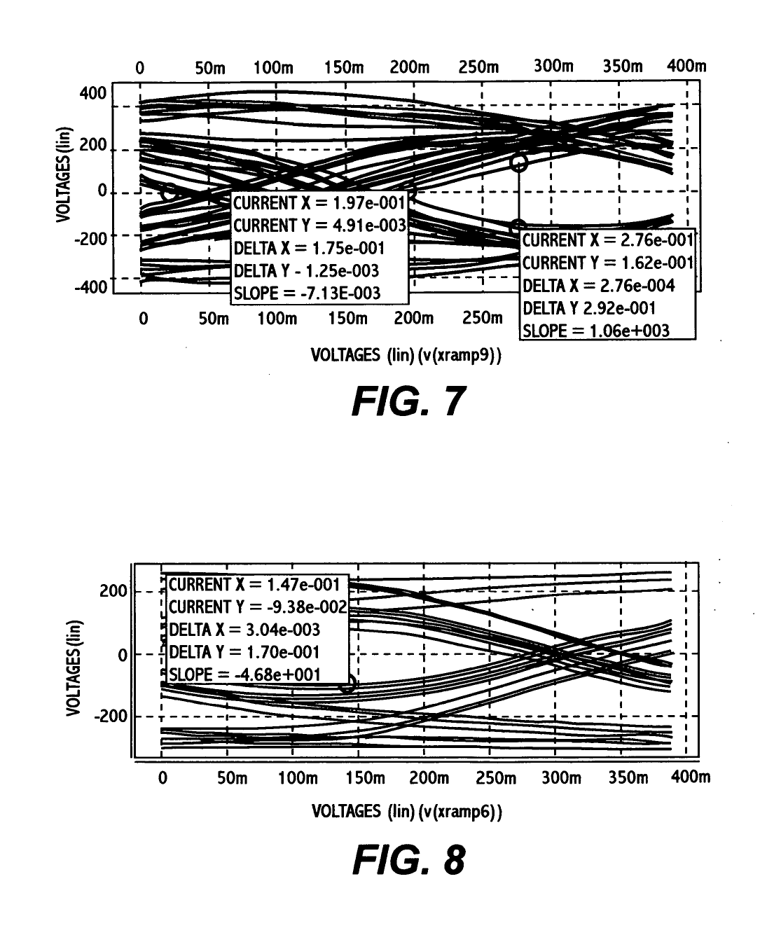

FIG. 7 shows a voltage-time eye diagram for the stub-resonant reference channel obtained based on the frequency response shown in FIG. 5, and FIG. 8 shows a voltage-time eye diagram for the loss-based channel. From a comparison of the graphs in FIGS. 5-8, it is evident that channels above the loss-based channel have more jitter.

Returning to FIG. 3, once the reference-channel stub resonator has been formed, it is coupled within the serial link so that a set of AC parameters may be developed to achieve an intended level of performance. (Block 120). The AC parameters may be developed by measuring performance of the reflection-based reference channel (Block 130), and then comparing that performance to a predetermined frequency response or jitter profile. This response, for example, may be the frequency response of the insertion-loss-based channel (Block 140), although another reference response may be used. If necessary, the parameters may be adjusted until the intended response or profile is obtained (Block 150), thereby resulting in the formulation of a final set of parameters (Block 160) that define optimal or otherwise intended performance characteristics of the transmitter and receiver in the link.

In performance testing the link, the transmitter connection and receiver connection to the link may be tested separately. In testing the transmitter connection, initially, the number of stubs on the reference channel and their spacing and size should be selected to ensure that the channel exhibits a maximum eye width closure, when driven with a reference transmitter connected to one end of the channel and a reference load to the other end. The reference transmitter is then replaced with the actual transmitter to be used in the link. The frequency response of the link is then measured with the reference load still attached. If the eye width deviates from a predetermined specification (e.g., one selected to bound jitter performance based on the capabilities of the silicon receiver) at the reference load, then one or more AC parameters (e.g., equalization and/or algorithms of the transmitter and/or receiver) are adjusted until the eye width satisfies this specification, e.g., demonstrates a maximum eye-width closure.

In testing the receiver connection, it should be confirmed that the number of stubs on the reference channel and their spacing and size cause the channel to exhibit a maximum eye width closure, when driven with a reference transmitter connected to one end of the channel and a reference load to the other end. The reference load (e.g., a resistive termination) is then replaced with the actual receiver to be used in the link. The frequency response of the link is then measured with the reference transmitter still attached and the bit-error is observed. If the bit-error rate deviates from a predetermined rate, then one or more AC parameters are adjusted until the predetermined rate is satisfied for any and all signals transmitted through the reference channel. These AC parameters include but are not limited to the equalization or algorithms of the transmitter and/or receiver, or parameters associated with the clock.

Once testing of the transmitter and receiver is complete, link parameters will be formulated which ensures interoperability among the various components in the link, and that a intended frequency response is obtained which, for example, optimally suppresses jitter and insertion loss. In this embodiment, the reference channel is only used for silicon compliance and the stub resonator serves as a physical manifestation of the channel wiggle limits.

At least some of the embodiments described herein may have improved accuracy and reduced complexity. For example, in conventional methods when specifying the components that comprise an end-to-end link for a serial channel, parameters are set which achieve interoperability at the package pin boundaries of the components. Using this method, the measurement point may therefore correspond to a physically accessible boundary, which allows each link component to be specified and characterized independently of the others.

The conventional method starts to become cumbersome at high bit rates because it relies on the assumption that no interactions exist between the transmitter, channel, and receiver. In reality, interactions do exist such as interactions between jitter and the channel and interactions between the transmitter or receiver package and the channel. Consequently, the conventional package-pin-based specification method requires a large number of parameters (e.g., channel-dependent jitter, channel-independent jitter, transmitter voltage and time margins into an ideal load) to be specified. Generally, the more parameters that must be specified, the greater amount of guard-banding that is necessary because each parameter has some measurement tolerance. Also, the more parameters that must be specified, the more difficulty required in setting up the measurements.

The reference-channel-based measurements determined by the embodiments of the present invention overcome these drawbacks by not attempting to isolate transmitter-channel or channel-receiver interactions. Instead, the interactions with a worst-case reference channel are automatically embedded in the measurement, and therefore a single voltage-time eye measurement is sufficient to characterize either a transmitter or receiver. Moreover, any given channel can be characterized by comparison with the loss vs. frequency of the insertion- and return-loss-based reference channels.

Additionally, at least some of the embodiments of the present invention may use a minimum eye width (maximum jitter) requirement, as opposed to a minimum eye height requirement. This is an improvement, as other methods require both eye height and eye width to achieve interoperability.

Another advantage may lie in the freedom afforded transmitter and receiver designers. Because the method permits only a single voltage-time margin needs to be met to achieve interoperability, designers are free trade off such factors as silicon margins against package quality. The reference-channel-based specification method also has reduced complexity compared with conventional methods, making at least some of the embodiments described herein easier to implement. A potential 60% increase in the solution space may also be realized. All the foregoing benefits make at least some of the embodiments suitable for use in IEEE 802.3ap (10 GB Ethernet) applications, but this application is not the only application possible.

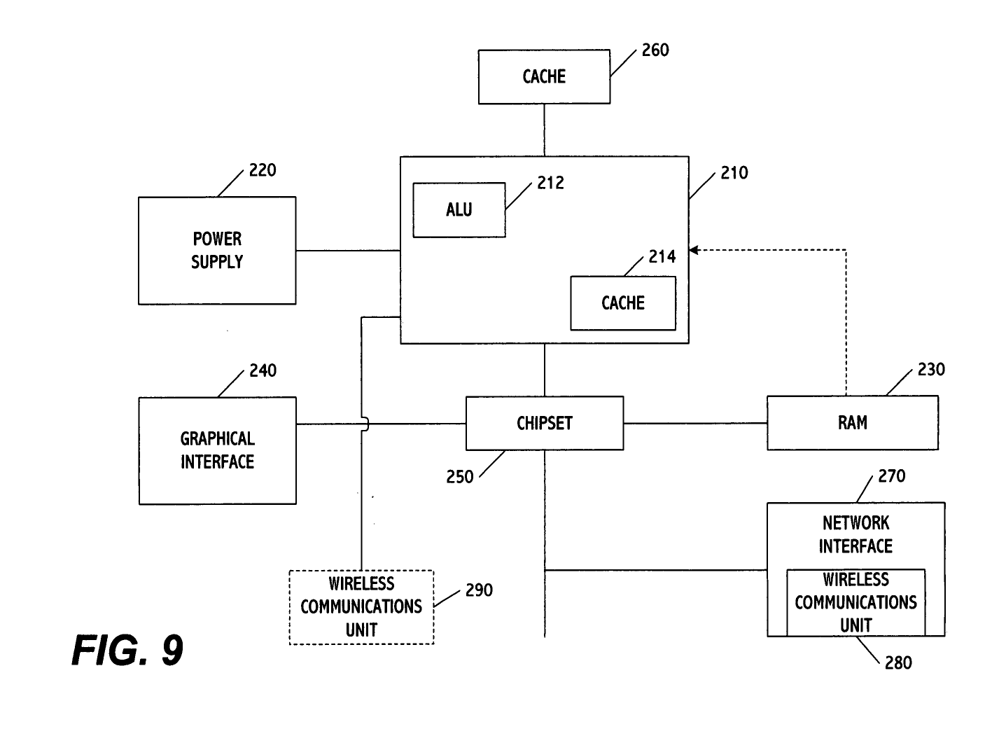

FIG. 9 is a diagram showing a processing system which includes a processor or controller 210, a power supply 220, and a memory 230 which, for example, may be a random-access memory. The processor includes an arithmetic logic unit 212 and an internal cache 214. The system may also include a graphical interface 240, a chipset 250, a cache 260, a network interface 270, and a wireless communications unit 280, which may be incorporated within the network interface. Alternatively, or additionally, a communications unit 290 may be coupled to the processor, and a direct connection may exist between the memory and processor as well.

The processor may be a microprocessor or any other type of processor. If the processor is a microprocessor, it may be included on a chip die with all or any combination of the remaining features, or one or more of the remaining features may be electrically coupled to the microprocessor die through known connections and interfaces. In this system, the foregoing embodiments of the present invention may be used in an interconnect between the chipset and one or more, or even all, other elements in FIG. 9 for bounding or otherwise defining the performance of the channels therein.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A serial communications link, comprising:
a reference channel having a signal propagation axis; and
a plurality of projections disposed on the reference channel at predetermined angles relative to the signal propagation axis, wherein the projections are spaced to tune the reference channel to a predetermined jitter profile based on a data rate through the channel.

2. The serial communication link of claim 1, wherein the predetermined jitter profile corresponds to a minimum insertion loss based on said data rate.

3. The serial communications link of claim 2, wherein said data rate is a maximum data rate through the channel.

4. The serial communications link of claim 1, wherein the projections are equally spaced along the channel.

5. The serial communications link of claim 4, wherein the projections are separated by a spacing proportional to a predetermined fraction of a signal wavelength passing through the channel.

6. The serial communication link of claim 5, wherein the spacing at least substantially equals one-eighth of the signal wavelength through the channel.

7. The serial communications link of claim 5, wherein the signal wavelength is a maximum signaling rate frequency wavelength (λ) given by the following formula:
λ=(εᵣ·c)^{1/2}/Freq
where c is the speed of light, εᵣ is a dielectric constant of the channel, and Freq is the signal frequency.

8. The serial communications link of claim 1, wherein the projections have substantially equal lengths.

9. The serial communications link of claim 8, wherein the lengths of the projections and the spacing between the projections are at least substantially equal.

10. The serial communications link of claim 1, wherein the projections have different lengths.

11. The serial communications link of claim 1, wherein different lengths of the projections bound jitter in the link between upper and lower limits.

12. The serial communications link of claim 1, wherein the projections are at least substantially perpendicular to the signal propagation axis of the channel.

13. The serial communications link of claim 1, wherein at least two of the projections are disposed at different predetermined angles relative to the signal propagation axis of the channel.

14. A serial communications link, comprising:
a reference channel having a signal propagation axis; and
a plurality of projections disposed on the reference channel at predetermined angles relative to the signal propagation axis, wherein the projections are sized to tune the reference channel to a predetermined jitter profile based on a data rate through the channel.

15. The serial communications link of claim 14, wherein the projections have sizes proportional to a predetermined fraction of a signal wavelength passing through the channel.

16. The serial communications link of claim 14, wherein the projections have substantially equal lengths.

17. The serial communications link of claim 16, wherein the lengths of the projections and spacing between the projections are at least substantially equal.

18. The serial communications link of claim 14, wherein the projections have different lengths.

19. The serial communications link of claim 14, wherein different lengths of the projections bound jitter in the link between upper and lower limits.

20. The serial communications link of claim 14, wherein the projections are equally spaced along the channel.

21. The serial communications link of claim 20, wherein the projections are separated by a spacing proportional to a predetermined fraction of a signal wavelength passing through the channel.

22. A method for controlling link performance, comprising:
connecting a resonator in a reference channel, the resonator including a plurality of stubs which tune the reference channel to a predetermined jitter profile based on a data rate through the channel; and
adjusting one or more parameters of the link to conform the link to the predetermined jitter profile.

23. The method of claim 22, wherein lengths of the stubs tune the reference channel to the predetermined jitter profile.

24. The method of claim 22, wherein the stubs have an equal length.

25. The method of claim 22, wherein the stubs have different lengths which bound jitter in the channel between upper and lower limits.

26. The method of claim 22, wherein spacing between the stubs tune the reference channel to the predetermined jitter profile.

27. The method of claim 26, wherein the stubs are spaced by an equal length.

28. A system, comprising:
a chipset; and
an interconnect, between the chipset and a circuit, having:
a resonator in a reference channel and including a plurality of stubs which tune the reference channel to a predetermined jitter profile based on a data rate through the channel.

29. The system of claim 28, wherein the circuit is selected from the group consisting of a processor, a memory, a power supply, a graphical interface, a network interface, a cache, and a wireless communications unit.
